(19) United States
(12) Patent Application Publication
(10) Pub. No.: US 2018/0308071 A1
(43) Pub. Date: Oct. 25, 2018

(54) SYSTEM AND METHOD FOR VERIFYING VALIDITY OF A TRANSACTION BETWEEN TWO PARTIES

(71) Applicant: Audit Control Oy, Turku (FI)

(72) Inventor: Jaakko Gävert, Turku (FI)

(21) Appl. No.: 15/496,103

(22) Filed: Apr. 25, 2017

(51) Int. Cl. G06Q 20/06; G06Q 20/40

(52) U.S. Cl. CPC G06Q 20/06; G06Q 20/405

(57) ABSTRACT

A method for verifying a validity of a financial transaction between a first party and a second party by a third party, the method including obtaining a financial document from a first party device associated with the first party, wherein the financial document comprises a first pointer to a first storage of the first party device where the financial document is stored, a second pointer to a second storage of a second party device associated with the second party where the financial document is stored and a first information element; communicating a query to the second storage using the second pointer to access the financial document stored in the second storage, wherein the query comprises a second information element; obtaining a result of the query from the second party device; and validating the financial transaction between the first party and the second party based on the result of the query, wherein the financial transaction between the first party and the second party is validated based on a comparison between the first information element in the financial document obtained from the first party device, and the second information element.

### TECHNICAL FIELD

The present disclosure relates generally to a financial audit process, and more specifically, to a system and a method for verifying the validity of a financial transaction between two parties (e.g. a seller and a buyer).

### BACKGROUND

The financial audit process involves the careful and meticulous analysis of an organization's financial records, internal controls, accounting procedures and even its record keeping processes. During the financial audit process, an auditor has to verify a large number of financial documents and financial transactions and to identify any discrepancies in the data associated with the financial transactions. For example, in a financial transaction between a buyer and a seller, the financial audit process may require the auditor to manually compare and verify whether the corresponding data in the records of the buyer as well as the seller match with each other.

When there is a financial transaction between a first party and a second party, and the auditor is auditing the records of the first party, typically, the auditor may only be able to access the records of the first party, and the records of the second party are stored in a separate system. Thus it is cumbersome to manually cross verify data across different disparate systems, particularly when the volumes of transactions and the number of parties transacting with the first party is high.

Therefore, in light of the foregoing discussion, there exists a need to overcome the aforementioned drawbacks in existing methods and systems for conducting a financial audit due to the storage of financial documents in separate systems and difficulty in accessing relevant information across the separate systems for verification.

### SUMMARY

The present disclosure provides a method for verifying a validity of a financial transaction between a first party and a second party by a third party, the method comprising the steps of:
obtaining a financial document from a first party device associated with the first party, wherein the financial document comprises
   a first pointer to a first storage of the first party device where the financial document is stored;
   a second pointer to a second storage of a second party device associated with the second party where the financial document is stored; and
   a first information element;
communicating a query to the second storage using the second pointer to access the financial document stored in the second storage, wherein the query comprises a second information element;
obtaining a result of the query from the second party device; and
validating the financial transaction between the first party and the second party based on the result of the query, wherein the financial transaction between the first party and the second party is validated based on a comparison between the first information element in the financial document obtained from the first party device, and the second information element.

The present disclosure also provides one or more non-transitory computer readable storage mediums storing one or more sequences of instructions, which when executed by one or more processors, causes verifying a validity of a financial transaction between a first party and a second party by a third party, problem and change items, by performing the steps of:
obtaining a financial document from a first party device associated with the first party, wherein the financial document comprises
   a first pointer to a first storage of the first party device where the financial document is stored;
   a second pointer to a second storage of a second party device associated with the second party where the financial document is stored; and
   a first information element;
communicating a query to the second storage using the second pointer to access the financial document stored in the second storage, wherein the query comprises a second information element;
obtaining a result of the query from the second party device; and
validating the financial transaction between the first party and the second party based on the result of the query, wherein the financial transaction between the first party and the second party is validated based on a comparison between the first information element in the financial document obtained from the first party device, and the second information element.

The present disclosure further provides a financial transaction verification system for verifying a validity of a financial transaction between a first party and a second party, comprising a third party device that comprises
a processor; and
a memory configured to store program codes comprising:
   a financial document obtaining module implemented by the processor configured to obtain a financial document from a first party device associated with the first party, wherein the financial document comprises
      a first pointer to a first storage of the first party device where the financial document is stored;
      a second pointer to a second storage of a second party device associated with the second party where the financial document is stored; and
      a first information element;
   a querying module implemented by the processor configured to communicate a query to the second storage using the second pointer to access the financial document stored in the second storage, wherein the query comprises a second information element;
   a result obtaining module implemented by the processor configured to obtain a result of the query from the second party device; and
   a validating module implemented by the processor configured to validate the financial transaction between the first party and the second party based on the result of the query, wherein the financial transaction between the first party and the second party is validated based on a comparison between the first information element in the financial document obtained from the first party device and the second information element.

Embodiments of the present disclosure substantially eliminate or at least partially address the aforementioned problems in the prior art for conducting a financial audit due to the storage of financial documents in separate systems and difficulty in accessing relevant information across the separate systems for verification.

Additional aspects, advantages, features and objects of the present disclosure are made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 is a schematic illustration of a financial transaction verification system in accordance with an embodiment of the present disclosure;

FIG. 2 is a functional block diagram of a third party device in accordance with an embodiment of the present disclosure;

FIG. 3 is an interaction diagram illustrating a method of verifying a validity of a financial transaction between a first party and a second party in accordance with an embodiment of the present disclosure;

FIG. 4 is an exemplary tabular view of a financial document in accordance with an embodiment of the present disclosure;

FIG. 5 is an exemplary query that is communicated to a second storage by a third party device using a second pointer in accordance with an embodiment of the present disclosure;

FIG. 6 is an exemplary result of a query that is validated by a second storage in accordance with an embodiment of the present disclosure;

FIGS. 7A and 7B illustrate an exemplary invoice comprising information content in accordance with an embodiment of the present disclosure;

and

FIG. 8 is a flow diagram illustrating a method of verifying a validity of a financial transaction between a first party and a second party by a third party in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

The present disclosure provides a method for verifying a validity of a financial transaction between a first party and a second party by a third party, the method comprising the steps of:
obtaining a financial document from a first party device associated with the first party, wherein the financial document comprises
   a first pointer to a first storage of the first party device where the financial document is stored;
   a second pointer to a second storage of a second party device associated with the second party where the financial document is stored; and
   a first information element;
communicating a query to the second storage using the second pointer to access the financial document stored in the second storage, wherein the query comprises a second information element;
obtaining a result of the query from the second party device; and
validating the financial transaction between the first party and the second party based on the result of the query, wherein the financial transaction between the first party and the second party is validated based on a comparison between the first information element in the financial document obtained from the first party device, and the second information element.

The present method thus enables the third party to dynamically verify the validity of the financial transaction between the first party and the second party using the first pointer and the second pointer associated with the financial document. The method further enables storing of financial documents in separate systems and eliminates difficulty in accessing relevant information across the separate systems by the third party (e.g. an auditor) for verification by providing the financial document with the first pointer to the first storage and the second pointer to the second storage.

The first party may be a user (e.g. a person who sends an invoice), a seller, an organization etc. The second party may be a user (a person who receives an invoice), a buyer etc. The third party may be an auditor or a person who either verifies the validity of the financial transaction between the first party and the second party or conducts a financial audit. In an embodiment, the first party is an organization A and the second party is an organization B. The first party and the second party may both be clients of the third party, or only one of them may be a client of the third party. The first storage and the second storage may be server databases that are accessed by the first party device and the second party device respectively through a network. Further the first storage and the second storage may be accessed by the third party device.

In an embodiment, the financial document is an invoice and the and the first information element and the second information element are selected from at least one of an invoiced amount, a due date for payment of the invoiced amount and an invoice identity code. For example, the financial document may be a paper invoice or a PDF invoice that is sent via an email. The information element may be for example an amount entered in the invoice or a due date for payment of the invoiced amount or an invoice ID etc. By invoice identity (or ID) code it is meant for example the invoice number.

In an embodiment, the first pointer comprises a uniform resource locator (URL) associated with the financial document. The first pointer may thus be a unique identification number associated with the invoice or a communication address of the first party etc. The first pointer may indeed be any means for allowing the second party or the third party to send the query to the first storage.

In an embodiment, the second pointer comprises a uniform resource locator (URL) associated with the financial document. This second pointer may thus also be a unique identification number associated with the invoice or a communication address of the second party etc. The second pointer may be any means for allowing the first party or the third party to send the query to the second storage.

The first pointer may thus be used to easily access the financial document stored in the first storage associated with the first party device. The combination of the URL and information associated with the financial document may be used to access information related to the financial document from the first storage.

The query may be generated by a third party device and the third party device communicates the query using the second pointer to the second storage through a network, for example. The query may comprise for example an invoice number and the amount entered in the invoice. The second pointer may help the third party to access information related to the financial document that is stored in the second storage.

In an embodiment, the third party device obtains the result of the query from the second storage. The result of the query may comprise for example the invoice number and the amount entered in the invoice associated with a financial transaction along with its verification status.

Indeed, the method may comprise updating a verification status field, based on whether the financial transaction is validated or not. Indeed, the second storage may update a verification status of a financial transaction as ‘yes’ if the first information element matches with the second information element, i.e. the query sent by the third party device is positive. Similarly, the second storage may update the verification status as ‘no’ in the verification status field when the query sent by the third party device is negative (e.g. the amount due in the invoice 12345 not equal to 32.34 euro).

In an embodiment, the verification status may be updated by the third party on the third party device based on the comparison between the first information element and the second information element. In another embodiment, the verification status field is updated by the second storage associated with the second party based on the comparison between the first information element and the second information element. In an embodiment, the extensible business reporting language standard is the financial transaction reporting standard that is used to indicate the financial transaction between the first party and the second party. The extensible business reporting language standard may help the third party in audit review of a financial document. The financial document may be in extensible business reporting language standard and one or more new fields may be added to the extensible business reporting language standard. The one or more new fields may comprise the first pointer to the first storage associated with the first party device, the second pointer to the second storage associated with the second party device and/or a status of the financial transaction between the first party and the second party. According to embodiments the pointer fields are included in an extensible business reporting language standard

The third party device may thus communicate the query to the second storage to verify any of the fields (e.g. a verification field) in the financial document. The verification field represents any field in the financial document which is verified by comparing the first information element and the second information element associated with the financial document. For example, if the verification field is an amount to be paid-field, the query comprises, for example “is an amount due in the invoice 12345 equal to 32.34 euro”. The method and system may also use more than one verification field.

In an embodiment, the third party device thus validates the financial transaction between the first party and the second party based on the comparison between the first information element of the financial document and the second information element.

In another embodiment, the second storage validates the financial transaction between the first party and the second party by comparing the first information element of the financial document and the second information element obtained from the third party device. The second storage may thus validate the financial transaction between the first party and the second party by comparing for example the invoice ID and the invoiced amount in the first information element with the invoice ID and the invoiced amount in the second information element. According to embodiment the validation result is communicated from the second party device to a third party device. In alternative embodiment the validation can be carried out in the third party storage by comparing the first information element of the financial document and the second information element. According to alternative embodiment the third party might request from the second party a check sum or similar related to a part or entire financial document. The check sum is compared in the third part device to form the validation result.

In an example embodiment, a first party is a seller, a second party is a buyer and a third party is an auditor. The seller is a client of the auditor. The seller may send invoices (e.g. financial documents) to one or more buyers during a financial year using a first party device. The financial document(s) may be stored in a first storage associated with the seller. Similarly, the one or more buyers may receive the financial document(s) from the seller and store the financial document(s) in a second storage associated with the buyer. There can indeed be multiple second parties, such as 2, 3, 4, 5, 6, 10, 15, 30 or more second parties. The financial document comprises a first pointer to the first storage associated with the seller and a second pointer to second storage associated with one buyer. During a financial auditing process, the auditor of the seller may use one or more second pointers associated with the financial documents to make queries to one or more second storages. In an embodiment, the auditor makes an individual query for each second storage associated with each buyer using a third party device. The auditor may obtain results of queries from the second storage associated with each buyer using the third party device to verify the validity of the financial transaction. The auditor may validate the financial transaction between the seller and the buyer using the third party device by comparing a first information element and a second information element associated with the financial document. The auditor may validate the financial transaction in the financial document based on the comparison between the first information element and the second information element. In an embodiment, if there are some unclear invoices identified during the financial audit process, a manual checking process is initiated. Similarly, the auditor may verify the validity of the financial transaction between the buyer and the seller when the buyer is a client of the auditor. Typically, every seller is also buyer at some point of time.

According to an embodiment, the financial document is generated by the first party in the first party device, communicated from the first party device to the second party device, and stored in the second storage associated with the second party device. In an embodiment, the financial document is generated by the first party in the first party device using an invoice exchange protocol. Indeed, the financial document may be created to conform to a document exchange protocol. The financial document may be manually generated by the first party.

According to yet another embodiment, the method further comprises generating a binary indicative information at the second party device, based on the comparison between the first information element and the second information element.

According to yet another embodiment, the method further comprises blocking the query by the second party device when a third party device sends the same query more than two times to the second storage associated with the second party device. The second storage may store each query obtained from the third party device. In another embodiment, the second storage blocks the query when the same query is already sent by the third party device more than one time to the second storage.

The present disclosure provides also one or more non-transitory computer readable storage mediums storing one or more sequences of instructions, which when executed by one or more processors, causes verifying a validity of a financial transaction between a first party and a second party by a third party, problem and change items, by performing the steps of:
obtaining a financial document from a first party device associated with the first party, wherein the financial document comprises
   a first pointer to a first storage of the first party device where the financial document is stored;
   a second pointer to a second storage of a second party device associated with the second party where the financial document is stored; and
   a first information element;
communicating a query to the second storage using the second pointer to access the financial document stored in the second storage, wherein the query comprises a second information element;
obtaining a result of the query from the second party device; and
validating the financial transaction between the first party and the second party based on the result of the query, wherein the financial transaction between the first party and the second party is validated based on a comparison between the first information element in the financial document obtained from the first party device, and the second information element.

According to an embodiment, the financial document is generated by the first party in the first party device, communicated from the first party device to the second party device, and stored in the second storage associated with the second party device.

The advantages of the present computer readable storage mediums are thus identical to those disclosed above in connection with the present method and the embodiments listed above in connection with the method apply mutatis mutandis to the computer readable storage mediums.

The present disclosure provides also a financial transaction verification system for verifying a validity of a financial transaction between a first party and a second party, comprising a third party device that comprises
a processor; and
a memory configured to store program codes comprising:
   a financial document obtaining module implemented by the processor configured to obtain a financial document from a first party device associated with the first party, wherein the financial document comprises
      a first pointer to a first storage of the first party device where the financial document is stored;
      a second pointer to a second storage of a second party device associated with the second party where the financial document is stored; and
      a first information element;
   a querying module implemented by the processor configured to communicate a query to the second storage using the second pointer to access the financial document stored in the second storage, wherein the query comprises a second information element;
   a result obtaining module implemented by the processor configured to obtain a result of the query from the second party device; and
   a validating module implemented by the processor configured to validate the financial transaction between the first party and the second party based on the result of the query, wherein the financial transaction between the first party and the second party is validated based on a comparison between the first information element in the financial document obtained from the first party device and the second information element.

According to an embodiment, the financial transaction verification system comprises a verification status field updating module. The verification status filed updating module can be implemented by the processor of the second device associated with the second party. Resulting verification information (on whether the financial transaction is validated or not) is communicated to the third party devices and can be stored in a database of the third party device associated with the third party. According to still another embodiment, the financial document is created to conform to a document exchange protocol.

In an embodiment, the memory may further comprise a database that stores the financial document obtained from the first storage. The financial transaction verification system may be used to dynamically verify the validity of the financial transaction between the first party and the second party using the first pointer and the second pointer associated with the financial document. The financial transaction verification system may be used to create the financial document with the first pointer to the first party and the second pointer to the second party, thereby eliminates difficulty in accessing relevant information across the separate systems by the third party (e.g. an auditor) for verification. The financial transaction verification system helps the third party to verify large volume of the financial transactions between the first party and the second party in a short span of time.

The third party device may be communicatively connected to the first party device and the second party device through a network. In one embodiment, the third party device may be connected to a server (e.g. an external server). The server may partially comprise the above modules to verify the validity of the financial transaction between the first party and the second party. In another embodiment, the server may comprise all the above modules to verify the validity of the financial transaction. The third party device may be connected to more than one server that may comprise one or more of the above modules. The financial transaction between the first party and the second party may be validated in the server, or in the third party device.

The advantages of the present system are thus identical to those disclosed above in connection with the present method and the embodiments listed above in connection with the method apply mutatis mutandis to the system.

Embodiments of the present disclosure may eliminate the limitations in conducting a financial audit due to the storage of financial documents in separate systems and difficulty in accessing relevant information across the separate systems for verification. The embodiments of the present disclosure may create financial documents with the first pointer and the second pointer that are used to access the storage associated with the first party and the second party to conduct the financial audit.

### DETAILED DESCRIPTION OF THE DRAWINGS

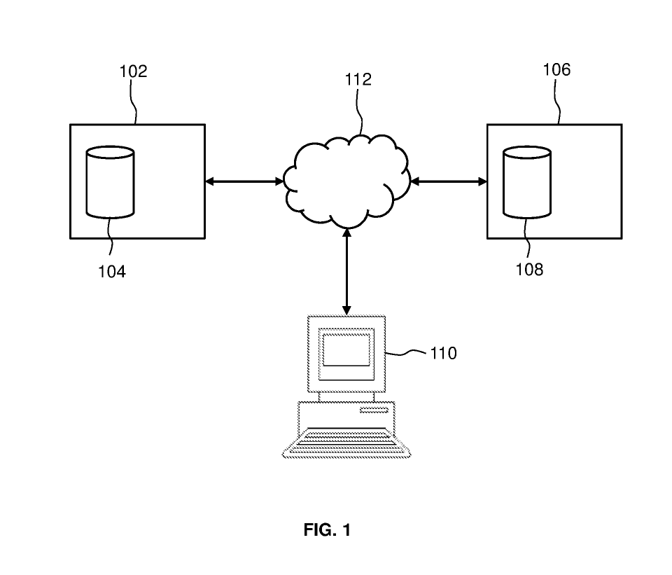

FIG. 1 is a schematic illustration of a financial transaction verification system in accordance with an embodiment of the present disclosure.

The financial transaction verification system comprises a first party device 102, a first storage 104, a second party device 106, a second storage 108, a third party device 110 and a network 112. The first party device 102 creates a financial document related to a financial transaction between a first party (e.g. a seller) and a second party (e.g. a buyer). The financial document comprises a first pointer to the first storage 104 of the first party device 102, a second pointer to the second storage 108 of the second party device 106 and a first information element. Once the financial document is created, the first party device 102 stores the financial document in the first storage 104. The first party device 102 then sends the financial document related to the financial transaction to the second party device 106 through the network 112. The second party device 106 receives the financial document from the first party device 102 and stores the financial document in the second storage 108. The first storage 104 sends the financial document to the third-party device 110 to verify the validity of the financial transaction. The third-party device 110 communicates a query to the second storage 108 using the second pointer to access the financial document stored in the second storage 108. The third-party device 110 obtains a result of the query from the second party device 106. The third-party device 110 validates the financial transaction between the first party and the second party based on the result of the query.

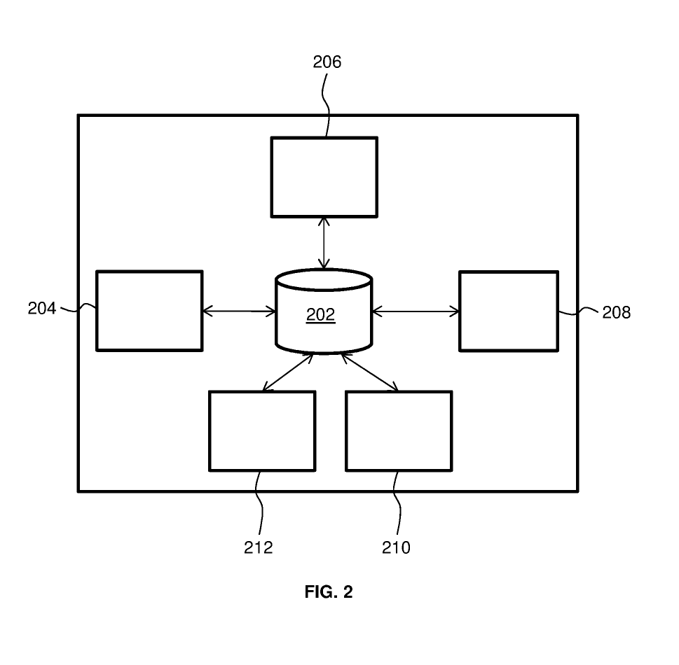

FIG. 2 is a functional block diagram of a second party device in accordance with an embodiment of the present disclosure. The functional block diagram of the second party device comprises a database 202, a financial document obtaining module 204, a querying module 206, a result obtaining module 208, a validating module 210 and a verification status field updating module 212. These modules function as has been described above. According to embodiment the third party device can comprise same blocks as the second party device but typically the validating module 210 is not needed in the third party device since the validation takes place in the second party device.

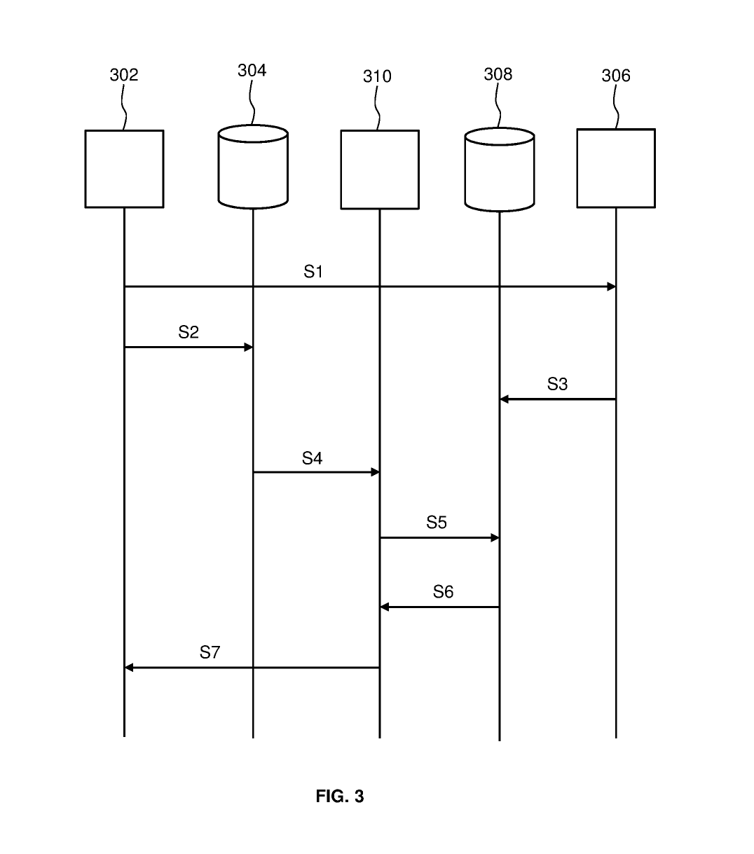

FIG. 3 is an interaction diagram illustrating a method of verifying a validity of a financial transaction between a first party and a second party in accordance with an embodiment of the present disclosure. At step S1, a first party device 302 sends a financial document related to the financial transaction between the first party and the second party to a second party device 306. At step S2, the first party device 302 stores the financial document in a first storage 304. At step S3, the second party device 306 stores the financial document in a second storage 308. At step S4, the first storage 304 associated with the first party device 302 sends the financial document to the third-party device 310 to verify the validity of the financial transaction between the first party and the second party. At step S5, the third-party device 310 communicates a query to the second storage 308 using a second pointer to access the financial document stored in the second storage 308. At step S6, the third-party device 310 obtains a result of the query from the second party device 306. At step S7, the third-party device 310 validates the financial transaction based on the result of the query and communicates the validity of the financial transaction to the first party device 302.

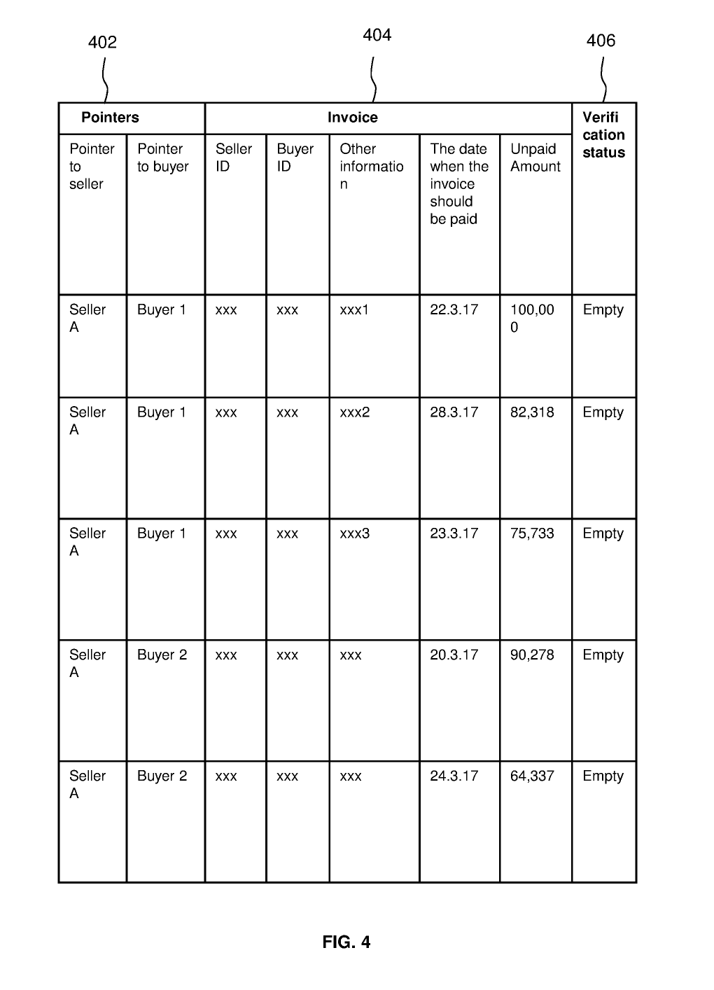

FIG. 4 is an exemplary tabular view of a financial document in accordance with an embodiment of the present disclosure. The exemplary tabular view of the financial document comprises pointer fields 402, invoice fields 404 and a verification status field 406. The pointer fields 402 comprise a pointer to a seller (e.g. a first pointer of a first party) and a pointer to one or more buyers (e.g. a second pointer of a second party). The invoice fields 404 comprise (a) a seller ID field that comprises a unique identification code for the seller, (b) a buyer ID field that comprises a unique identification code for the buyer, (c) an other information field that may comprise any other information which may be included in the financial document, (d) a date field that represents a date when an invoiced amount should be paid to the seller and (e) an unpaid amount field that represents an amount that is due. The verification status field 406 represents a status of a financial transaction.

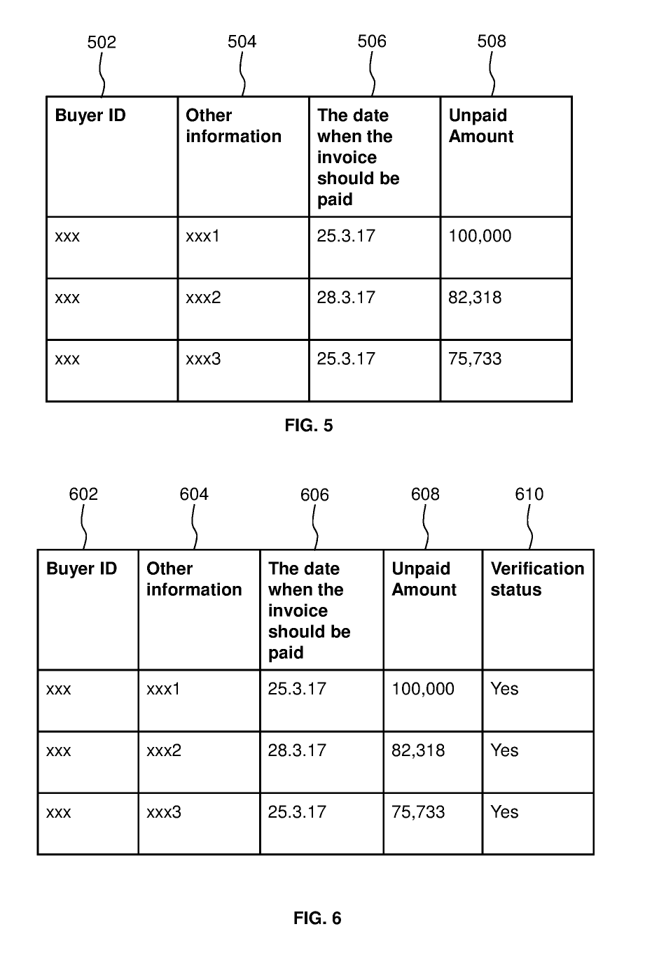

FIG. 5 is an exemplary query that is communicated to a second storage by a third party device using a second pointer in accordance with an embodiment of the present disclosure. The third party device generates the query based on a financial document obtained from a seller (e.g. a first party device) and communicates the query to the second storage associated with a buyer (e.g. a second party device) using the second pointer. The query comprises a second information element. The query is communicated to the second storage for verifying a validity of a financial transaction between the seller and the buyer. The second information element comprises (a) a buyer ID field 502 that comprises a unique identification code for the buyer (e.g. the second party), (b) an other information field 504 that may comprise any other information related to an invoice which may be included in the financial document, (c) a date field 506 that represents a date when an invoiced amount should be paid to the seller and (d) an unpaid amount field 508 that represents an amount that is due.

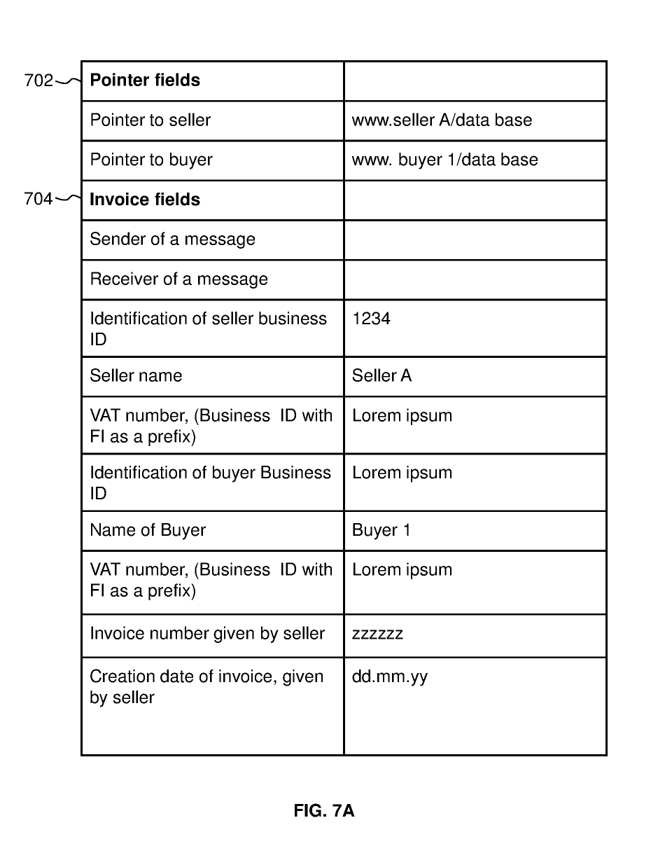

FIG. 6 is an exemplary result of a query that is validated by a second storage in accordance with an embodiment of the present disclosure. The second storage compares a second information element (e.g. a date and a due amount) associated with the query with a first information element (e.g. a date and a due amount) associated with a financial document that is stored in the second storage. The second storage updates a verification status field as ‘Yes’ if the first information element matches with the second information element and generates the result of the query. The financial transaction between a seller (e.g. a first party) and a buyer (e.g. a second party) is validated based on the result of the query. The result of the query is obtained by a third party device from the second party device. The result of the query comprises (a) a buyer ID field 602 that comprises a unique identification code for the second party, (b) an other information field 604 that may comprise any other information related to an invoice which may be included in the financial document, (c) a date field 606 that represents a date when an invoiced amount should be paid to a first party, (d) an unpaid amount field 608 that represents an amount that is due and (e) a verification status field 610 that represents a status (e.g. ‘yes’ or ‘no’) of a financial transaction between a seller (e.g. first party) and a buyer (e.g. second party).

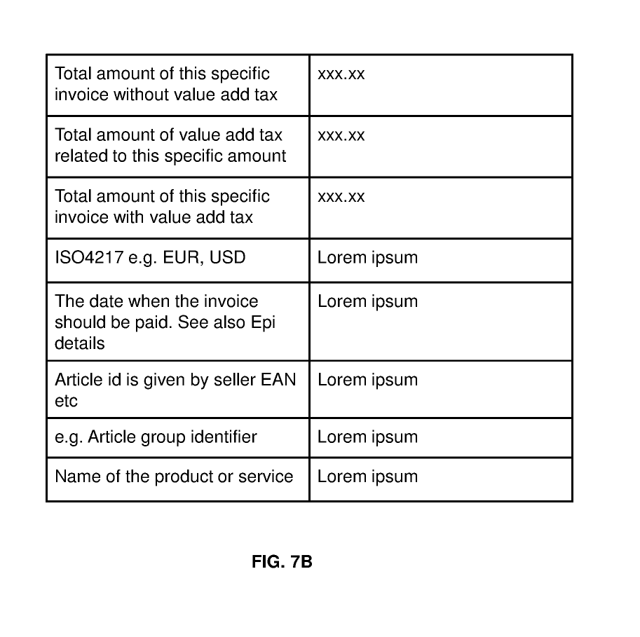

FIGS. 7A and 7B illustrate an exemplary invoice comprising information content in accordance with an embodiment of the present disclosure. The exemplary invoice comprises pointer fields 702 and invoice fields 704. The pointer fields 702 comprise a pointer to seller database (e.g. a first pointer to a first storage) and a pointer to buyer database (e.g. a second pointer to a second storage). The invoice fields 704 comprise (a) message fields that represent a sender and a receiver of a message, (b) an identification of the seller (e.g. a first party) business ID, (c) a name of the seller, (d) a VAT number of the seller, (e) an identification of a buyer (e.g. a second party) business ID, (f) a name of the buyer, (g) a VAT number of the buyer, (h) an invoice number provided by the seller, (i) a date when the invoice is created by the seller, (j) an amount associated with the invoice, (k) an amount of tax for the invoice, (l) a total amount that includes of the tax amount, (m) a date when an invoiced amount has been paid to the seller, (n) an article ID that is given by the seller, (o) an article group identifier and (p) a name of a product or a service provided by the seller to the buyer.

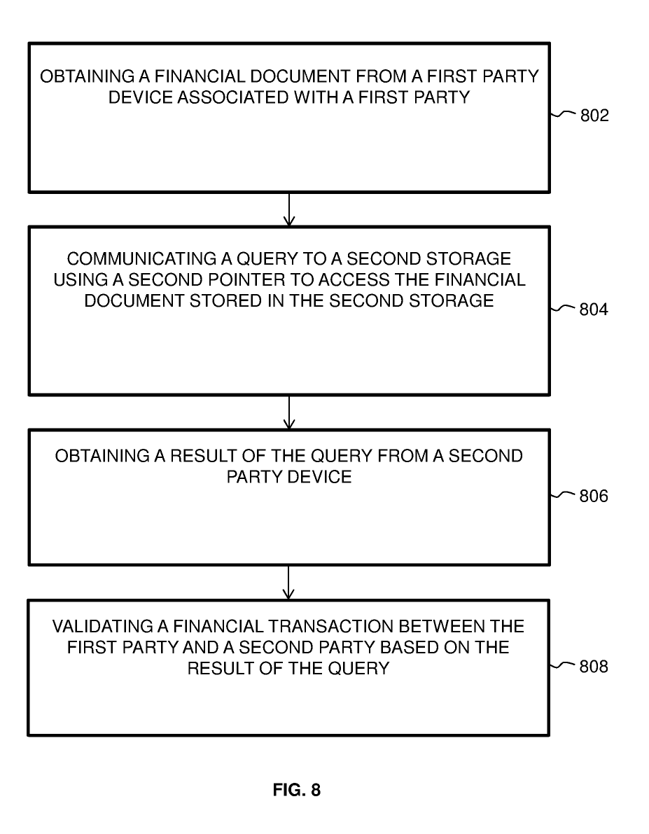

FIG. 8 is a flow diagram illustrating a method of verifying a validity of a financial transaction between a first party and a second party by a third party in accordance with an embodiment of the present disclosure. At step 802, a financial document is obtained from a first party device associated with the first party. The financial document comprises (a) a first pointer to a first storage of the first party device where the financial document is stored, (b) a second pointer to a second storage of a second party device associated with the second party where the financial document is stored and (c) a first information element. At step 804, a query is communicated to the second storage using the second pointer to access the financial document stored in the second storage. The query comprises a second information element. At step 806, the result of the query is obtained from the second party device. At step 808, the financial transaction between the first party and the second party is validated based on the result of the query. The financial transaction between the first party and the second party is validated based on a comparison between the first information element in the financial document obtained from the first party device and the second information element.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for verifying a validity of a financial transaction between a first party and a second party by a third party, the method comprising:
obtaining a financial document from a first party device associated with the first party, wherein the financial document comprises:
a first pointer to a first storage of the first party device where the financial document is stored;
a second pointer to a second storage of a second party device associated with the second party where the financial document is stored; and
a first information element;
communicating a query to the second storage using the second pointer to access the financial document stored in the second storage, wherein the query comprises a second information element;
obtaining a result of the query from the second party device; and
validating the financial transaction between the first party and the second party based on the result of the query, wherein the financial transaction between the first party and the second party is validated based on a comparison between the first information element in the financial document obtained from the first party device, and the second information element.

2. A method according to claim 1, wherein the financial document is generated by the first party in the first party device, communicated from the first party device to the second party device, and stored in the second storage associated with the second party device.

3. A method according to claim 1, further comprising updating a verification status field based on whether the financial transaction is validated or not.

4. A method according to claim 3, wherein the pointer fields are included in an extensible business reporting language standard.

5. A method according to claim 1, wherein the first pointer comprises a uniform resource locator associated with the financial document.

6. A method according to claim 1, further comprising generating a binary indicative information at the second party device, based on the comparison between the first information element and the second information element.

7. A method according to claim 1, wherein the financial document is created to conform to a document exchange protocol.

8. A method according to claim 1, wherein the financial document is an invoice, and the first information element and the second information element are selected from at least one of an invoiced amount, a due date for payment of the invoiced amount and an invoice identity code.

9. A method according to claim 1, further comprising blocking the query by the second party device when a third party device sends the same query more than two times to the second storage associated with the second party device.

10. One or more non-transitory computer readable storage mediums storing one or more sequences of instructions, which when executed by one or more processors, causes verification of validity of a financial transaction between a first party and a second party by a third party, by performing the steps of:
obtaining a financial document from a first party device associated with the first party, wherein the financial document comprises
a first pointer to a first storage of the first party device where the financial document is stored;
a second pointer to a second storage of a second party device associated with the second party where the financial document is stored; and
a first information element;
communicating a query to the second storage using the second pointer to access the financial document stored in the second storage, wherein the query comprises a second information element;
obtaining a result of the query from the second party device; and
validating the financial transaction between the first party and the second party based on the result of the query, wherein the financial transaction between the first party and the second party is validated based on a comparison between the first information element in the financial document obtained from the first party device, and the second information element.

11. A financial transaction verification system for verifying a validity of a financial transaction between a first party and a second party, comprising a third party device that comprises
a processor; and
a memory configured to store program codes comprising:
a financial document obtaining module implemented by the processor configured to obtain a financial document from a first party device associated with the first party, wherein the financial document comprises
a first pointer to a first storage of the first party device where the financial document is stored;
a second pointer to a second storage of a second party device associated with the second party where the financial document is stored; and
a first information element;
a querying module implemented by the processor configured to communicate a query to the second storage using the second pointer to access the financial document stored in the second storage, wherein the query comprises a second information element;
a result obtaining module implemented by the processor configured to obtain a result of the query from the second party device; and
a validating module implemented by the processor configured to validate the financial transaction between the first party and the second party based on the result of the query, wherein the financial transaction between the first party and the second party is validated based on a comparison between the first information element in the financial document obtained from the first party device and the second information element.

12. A financial transaction verification system according to claim 11, further comprising a verification status field updating module implemented by the processor configured to update a verification status field by a second party on the second party device, based on whether the financial transaction is validated or not.

13. A financial transaction verification system according to claim 12, wherein the pointer fields are included in an extensible business reporting language standard.

14. A financial transaction verification system according to claim 11, wherein the financial document is created to conform to a document exchange protocol.
